(19) United States
(12) Patent Application Publication
(10) Pub. No.: US 2001/0007120 A1
(43) Pub. Date: Jul. 5, 2001

(54) Storage device

(75) Inventor: Satoshi Makita, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 09/792,845

(22) Filed: Feb. 23, 2001

Related U.S. Application Data
(63) Continuation of application No. PCT/JP99/03615, filed on Jul. 5, 1999.

(30) Foreign Application Priority Data
Sep. 11, 1998 (JP) 10-258796

(51) Int. Cl. G06F 12/00; G06F 11/30

(52) U.S. Cl. 711/112; 711/147; 711/170; 707/10; 711/164; 713/200

(57) ABSTRACT

The present invention relates to a storage device which is connected to a host computer and stores information processed in the host computer. An object of the present invention is to provide a storage device which can reduce a processing load of the host computer to which the storage device is connected. The present invention includes an external storage connected to a host computer. The external storage includes a file management unit, an optimization unit, a virus check unit, and a compression and expansion unit. The file management unit can perform management so that file systems of the host computer and a replaceable recording medium correspond.

### TECHNICAL FIELD

The present invention relates to storage devices, and more particularly to a storage device which is connected to a host computer to store data processed in the host computer.

### BACKGROUND ART

FIG. 1 is a diagram of a structure of an information processing system employing a conventional external storage, and FIG. 2 is a block diagram of the structure of the information processing system employing the conventional external storage.

An information processing system 1 employing the conventional external storage is structured so that an external storage 3 is connected to a host computer 2.

The external storage 3 is a recording and/or reproduction device, which employs a magneto-optical recording medium as a replaceable recording medium 4. The replaceable recording medium 4 is placed in the external storage 3 so that the external storage 3 writes information to and reads information from the replaceable recording medium 4 based on a command from the host computer 2.

The host computer 2 includes an interface unit 11, a memory management unit 12, a file management unit 13, and an.OS control unit 14. The interface unit 11 is connected to the external storage 3 to exchange data.

The memory management unit 12 manages a memory included in the host computer 2.

The file management unit 13 manages the storage of files into, the readout and deletion of files from, and access rights to the recording medium 4 of the external storage 3.

The OS control unit 14 controls the interface unit 11, the memory management unit 12, and the file management unit 13 by means of an operating system.

The external storage 3 includes an interface unit 21 and a storage unit 22.

The interface unit 21 exchanges data with the host computer 2.

The storage unit 22 includes a controller 22a, a signal processing unit 22b, a servo circuit 22c, a loading unit 22d, an optical system 22e, an optical pickup 22f, an electromagnet 22g, a positioner 22h, a spindle motor 22i, and a loading switch 22j.

The controller 22a controls the loading unit 22d based on an operation of the loading switch 22j. The loading unit 22d places the recording medium 4 in a predetermined loading position, and ejects outside the recording medium 4 placed in the predetermined loading position.

The controller 22a supplies information to be recorded to the signal processing unit 22b, and reproduced information supplied therefrom to the interface unit 21.

The signal processing unit 22b modulates the information to be recorded on the recording medium 4, and demodulates a signal read out from the recording medium 4. The recording signal modulated in the signal processing unit 22b is supplied to the optical system 22e. The optical system emits a laser beam based on the recording signal. The laser beam emitted from the optical system 22e is supplied to the optical pickup 22f.

The optical pickup 22f projects the laser beam supplied from the optical system 22e onto the recording medium 4. The information is written to the recording medium 4 by means of the laser beam projected from the optical pickup 22f and a magnetic field produced around the electromagnet 22g. The information recorded on the recording medium 4 by means of the laser beam projected from the optical pickup 22f is read out by detecting a reflected light of the laser beam projected from the optical pickup 22f. The laser beam reflected back from the recording medium 4 is returned to the optical system 22e by the optical pickup 22f to be converted into an electric signal. The signal converted in the optical system 22e is supplied to the signal processing unit 22b to be demodulated. The signal processing unit 22b is connected to the electromagnet 22g so that the magnetic field is applied to the recording medium 4 when information is recorded thereon.

The controller 22a is connected to the servo circuit 22c. The servo circuit 22c is connected to and controls the positioner 22h, and is also connected to the spindle motor 22i.

The description has been given above of an operation of the storage unit 22.

Next, a description will be given of a process of reading out a file from the recording medium 4.

FIG. 3 is a flowchart of a process performed by the information processing system employing the conventional external storage.

A command to read a file is supplied from a program stored in the host computer 2 to the OS control unit 14 (step Sl-l). The OS control unit 14 supplies the command to read the file to the file management unit 13.

The file management unit 13 determines from which position on the recording medium 4 to read data (step S1-2).

After the data reading position is determined in step S1-2, the interface unit 11 provides the external storage 3 with instructions on the data reading position and the amount of data to be read (step S1-3).

When the interface unit 11 outputs the data reading position and the data reading amount to the external storage 3 in step S1-3, the data reading position and amount are input to the interface unit 21 of the external storage 3. The interface unit 21 supplies the input data reading position and amount to the storage unit 22.

When the instructed data reading position and amount are input to the storage unit 22, the storage unit 22 reads out the instructed amount of data from the instructed position (step S1-4).

After reading out the instructed amount of data from the instructed position in step S1-4, the storage unit 22 transmits the instructed data to the host computer 2 via the interface unit 21 (step S1-5).

As described above, the information processing system employing the conventional external storage includes, in the operating system of the host computer 2, the file management unit 13 that controls a position on the recording medium 4, which position corresponds to data of data reading position and amount instructed by the program. Therefore, the host computer 2 causes the file management unit 13 to operate every time an access is made to the recording medium 4.

File management methods are disclosed in Japanese Laid-Open Patent Applications No. 4-237338, No. 61-228538, No. 7-182218, No. 56-111961, and No. 9-265355.

Japanese Laid-Open Patent Applications No. 4-237338, No. 61-228538, and No. 7-182218 disclose methods which uniformly manage files based on file management information.

Japanese Laid-Open Patent Application No. 56-111961 discloses a data file management device which is operated by a CPU in accordance with a file management program to make an access to an auxiliary storage.

Japanese Laid-Open Patent Application No. 9-265355 discloses a management device in which an access is made from a host device by reading information stored in an operation information storage unit, which is included in a file device and is accessible from the host device.

However, according to the conventional information processing system, a file management program for managing a recording medium included in an external storage is installed in a host computer to be executed thereby. Operating systems such as MS-DOS and UNIX requires different file management programs. Therefore, especially when a portable storage is disconnected from a system to be connected to another system, there is a problem that a file management program which complies with all the operating systems should be carried to be newly installed in an operating system without a file management program so that a recording medium may comply with any operating system before the recording medium becomes usable.

Further, since formatting of a recording medium, compression of data to be recorded on a recording medium, expansion of compressed data, and optimization are performed by the CPU of a host computer in accordance with a program installed therein, there is a problem that a processing load is imposed on the host computer.

Moreover, there is another problem that the management methods disclosed in Japanese Laid-Open Patent Applications No. 4-237338, No. 61-228538, No. 7-182218, and No. 56-111961 merely manage files stored in storages and do not comply with different operating systems.

Furthermore, the management device disclosed in Japanese Laid-Open Patent Application No. 9-265355 requires management information complying with an operating system to be installed in and managed by the host side as conventionally required. Therefore, there is a problem that a processing load imposed on the host side cannot be reduced.

### DISCLOSURE OF THE INVENTION

The present invention is made in the light of the above-described points and an object of the present invention is to provide a storage device which can reduce a processing load of a host computer to which the storage device is connected.

According to the present invention, a storage device, which is used under an environment in which the storage device is connected to and/or disconnected from each of a plurality of host computers, and records files on a recording medium, includes a file management unit which performs readout or writing management of files of the recording medium based on a command from one of the host computers.

According to the present invention, the file management unit is controlled by a plurality of file management programs corresponding to a plurality of file systems set in recording media which are usable in the storage device.

According to the present invention, the file management unit includes a formatting function of formatting the recording medium based on a predetermined file system.

According to the present invention, the file management unit detects a file system set in the recording medium, and manages a file to be recorded on the recording medium by one of file management programs corresponding to the detected file system.

According to the present invention, the formatting function automatically formats the recording medium based on the predetermined file system when the recording medium is not accessible.

According to the present invention, authorization is requested from the one of the host computers when the formatting function formats the recording medium based on the predetermined file system.

According to the present invention, an operation of said automatic formatting function is inhabitable.

According to the present invention, the file management unit enables or disables the formatting function based on a setting by the one of the host computers.

According to the present invention, files to be recorded on the recording medium can be compressed and compressed files can be expanded.

According to the present invention, the files of the recording medium can be optimized.

According to the present invention, a frequency of accesses from the one of the host computers to the recording medium is detected so that an optimization process is performed when the frequency is low.

According to the present invention, a virus check is performed on files to be recorded on the recording medium.

According to the present invention, the virus check is performed at a time of recording a file on or reading out a file from the recording medium, or based on a frequency of accesses from the one of the host computers to the recording medium.

According to the present invention, the formatting is performed in accordance with a format corresponding to an instruction from the one of the host computers.

According to the present invention, the one of the host computers is notified of an available format.

Thus, according to the present invention, since a host computer can automatically access a recording medium with the aid of a file management unit only by supplying a command to a storage device, the host computer does not have to execute a management program, thus reducing a processing load imposed on the host computer.

According to the present invention, by providing the external storage with a plurality of file management programs, the files of a recording medium can be managed by a file management program corresponding to the file management mechanism of a host computer to which the external storage is connected. Therefore, the external storage can be connected to the host computer without concern therefor.

According to the present invention, by detecting the management information of the recording medium and selecting from the file management programs a file management program corresponding to the detected management information, the files of the recording medium can be automatically managed by a file management program corresponding to the file management mechanism of a host computer. Therefore, the external storage can be connected to the host computer without concern therefor.

According to the present invention, by providing the file management unit included in an external storage with a formatting function of formatting a recording medium, it becomes unnecessary for the host computer to perform formatting. Therefore, since it is unnecessary to install a program for formatting a recording medium in the host computer and to execute the program therein, a processing load imposed on the host computer can be reduced.

According to the present invention, a recording medium can be automatically formatted by determining whether the recording medium is recorded with management information.

According to the present invention, when it is determined that the recording medium is not recorded with the management information, a user can confirm the formatting of the recording medium, which formatting is performed by requesting the host computer to authorize the operation of the formatting function.

According to the present invention, the operation of the formatting function can be freely set by the user.

According to the present invention, since the operation of the formatting function can be set from the host computer, the user can set the operation of the formatting function freely and easily.

According to the present invention, by providing the external storage with a compression and expansion means to compress files to be recorded on a recording medium and expand compressed files, an increased amount of information can be recorded on the recording medium. At this time, compression and expansion processes do not have to be performed in the host computer, thus reducing a processing load imposed on the host computer.

According to the present invention, by providing the external storage with an optimization means to record optimized files on a recording medium, an increased amount of information can be recorded on the recording medium. At this time, an optimization process does not have to be performed in the host computer, thus reducing a processing load imposed on the host computer.

According to the present invention, by detecting the frequency of accesses from the host computer to the recording medium and performing an optimization process at a time of a low access frequency, optimization of files can be performed automatically without hindering an access to the recording medium.

According to the present invention, by providing the external storage with a virus check means to perform a virus check on a file to be recorded on a recording medium, it becomes unnecessary for the host computer to perform a virus check, thus reducing a processing load imposed on the host computer. Further, a virus check can be performed even if a virus check program is not installed in the host computer.

According to the present invention, by performing a virus check at a time of recording a file on or reading out a file from the recording medium, or based on a frequency of accesses from the host computer to the recording medium, the virus check can be automatically performed in the external storage.

According to the present invention, formatting into a desired format can be performed.

According to the present invention, a host computer can recognize an available format and select a format.

### BRIEF DESCRIPTION OF THE DRAWINGS

FIG. 1 is a diagram of a structure of an information processing system employing a conventional external storage;

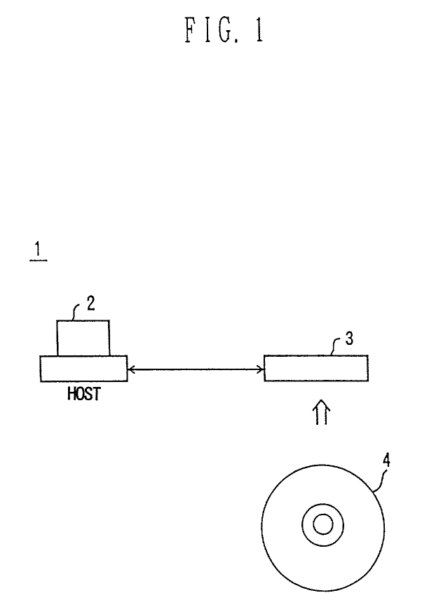

FIG. 2 is a block diagram of the structure of the information processing system employing the conventional external storage;

FIG. 3 is a flowchart of a process performed by the information processing system employing the conventional external storage;

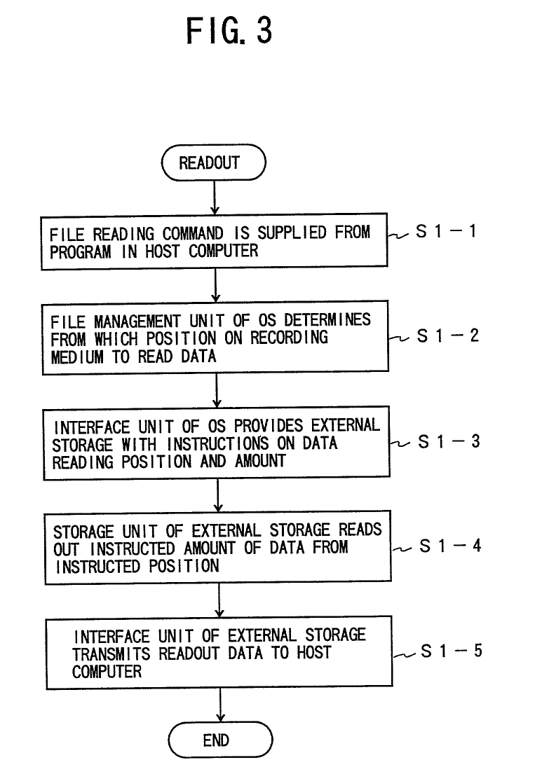

FIG. 4 is a block diagram of a structure of a first embodiment of the present invention;

FIG. 5 is a diagram for illustrating a file system of MS-DOS;

FIG. 6 is a diagram for illustrating a file system of UNIX;

FIG. 7 is a flowchart of a process performed by a host computer of the first embodiment of the present invention;

FIG. 8 is a flowchart of a process performed by an external storage of the first embodiment of the present invention;

FIG. 9 is a block diagram of an external storage of a second embodiment of the present invention;

FIG. 10 is a flowchart of a process of the second embodiment of the present invention;

FIG. 11 is a block diagram of a third embodiment of the present invention;

FIG. 12 is a flowchart of a process performed by an external storage of the third embodiment of the present invention;

FIG. 13 is a flowchart of a process performed by an external storage of a fourth embodiment of the present invention;

FIG. 14 is a flowchart of a process performed by an external storage of a fifth embodiment of the present invention;

FIG. 15 is a block diagram of an external storage of a sixth embodiment of the present invention;

FIG. 16 is a flowchart of a process performed by the external storage of the sixth embodiment of the present invention at a time of writing information;

FIG. 17 is a flowchart of a process performed by the external storage of the sixth embodiment of the present invention at a time of reading out information;

FIG. 18 is a flowchart of processes performed by an optimization unit and a virus check unit of the external storage of the sixth embodiment of the present invention;

FIG. 19 is a schematic diagram of a structure of a first example application of any of the external storages of the above-described first through sixth embodiments of the present invention;

FIG. 20 is a schematic diagram of a structure of a second example application of any of the external storages of the above-described first through sixth embodiments of the present invention; and

FIG. 21 is a schematic diagram of a structure of a third example application of any of the external storages of the above-described first through sixth embodiments of the present invention.

### BEST MODE FOR CARRYING OUT THE INVENTION

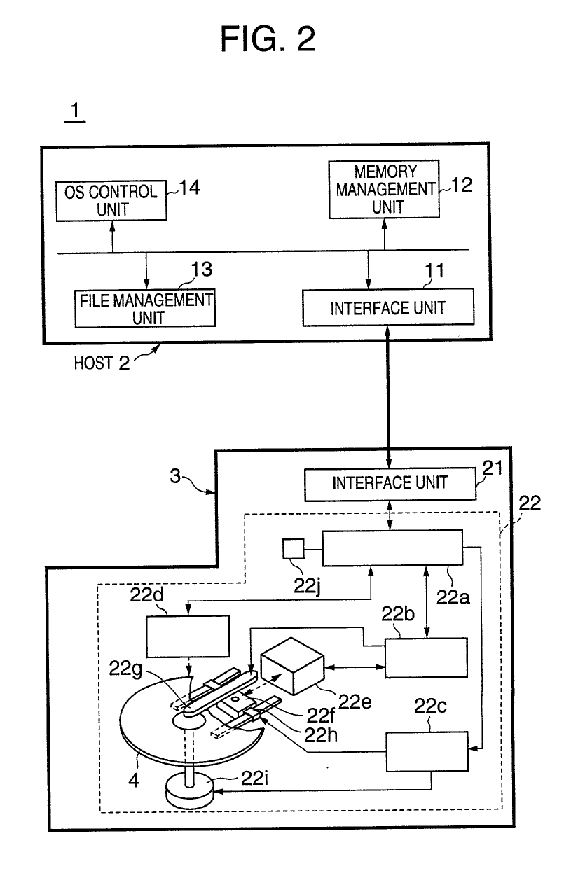

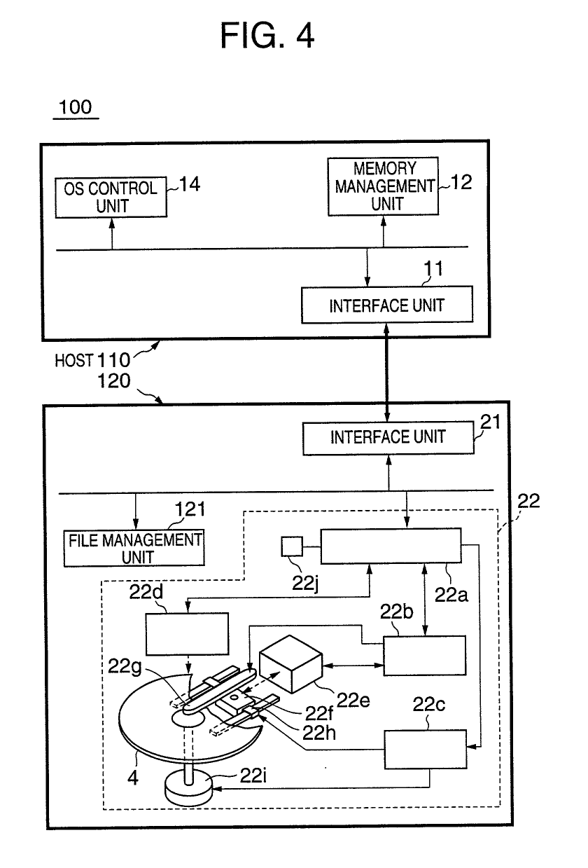

FIG. 4 is a block diagram of a structure of a first embodiment of the present invention. In the figure, the same elements as those of FIG. 2 are referred to by the same numerals, and a description thereof will be omitted.

An information processing system 100 according to this embodiment is structured so that an external storage 120 is connected to a host computer 110.

The host computer 110 includes the interface unit 11, the memory management unit 12, and the OS control unit 14, but does not have a file management unit.

The external storage 120 includes a file management unit 121 in addition to the interface unit 21 and the storage unit 22.

The file management unit 121 manages the storage of files into, the readout and deletion of files from, and access rights to the recording medium 4 of the external storage 120. The file management unit 121 includes programs for managing the recording medium 4 formatted into a desired logical format in formats corresponding to operation systems such as the 12-bit FAT (File Allocation Table) of MS-DOS, the 16-bit FAT of MS-DOS, and UNIX.

Here, a description will be given of file systems of MS-DOS and UNIX.

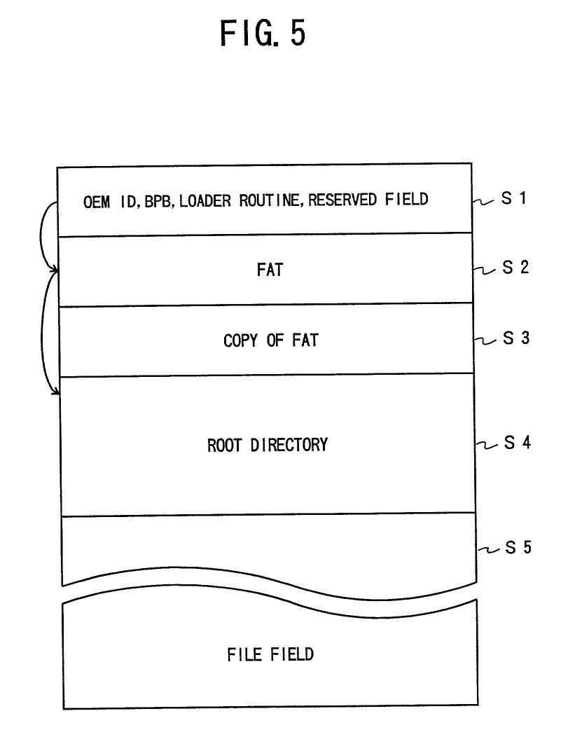

FIG. 5 is a diagram for illustrating the file system of MS-DOS.

The file system of MS-DOS is structured of a boot field S1, the FAT (File Allocation Table) S2, a FAT copy field S3, a root directory S4, and a file field S5.

The boot field S1 includes an OME-ID, a loader routine, a BPB which is recorded with information on a device, and a reserved field for options, which field follows the BPB.

Information recognizing the allocation of the file field S5 is written to the FAT S2 and the FAT copy field S3.

The root directory of the file field S5 is written to the root directory S4. The number of entries of the root directory written on the root directory S4 is fixed.

Data files, subdirectory files, and a space area are set in the file field S5. The volumes of the data files, the subdirectory files, and the space area are fixed.

According to the file system of MS-DOS, when the boot field S1 is read, the FAT S2 is read out. The FAT S2 is recorded with the start address and the number of blocks of the root directory. When the FAT S2 is read out, the root directory is read out by reading data of a predetermined number of blocks from the start address recorded in the FAT S2.

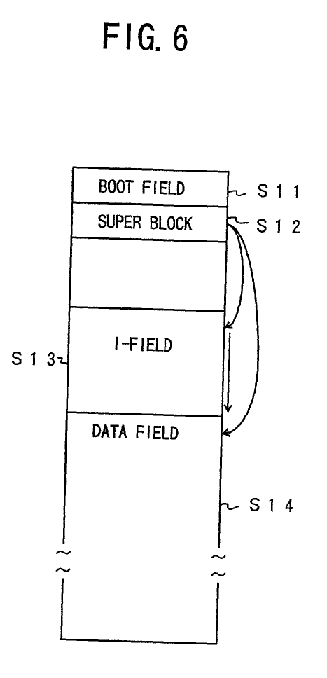

FIG. 6 is a diagram for illustrating the file system of UNIX.

The file system of UNIX is structured of a boot program S11, a super block S12, an i-field S13, and a data field S14.

The boot program S11 is recorded with a boot program. The super block S12 is recorded with the start address and the number of blocks of each of the i-field S13 and the data field S14.

The i-field S13 is recorded with i-nodes, which are fixed-length management information on files/directories. Each i-node is recorded with a table showing a correspondence among the type, number of directories, time of reference/creation/update, permission, user ID, byte length, and block numbers of what each i-node indicates. A root directory is recorded in a data block indicated by the second i-node of the i-field S13. The data field S14 is recorded with data and actual data of the root directory.

According to the file system of UNIX, in order to obtain the root directory, the boot program S11 is read first and then the super block S12 is read. By reading the super block S12, the starting address and the number of blocks of the i-field S13 are recognized. When the starting address and the number of blocks of the i-field S13 are recognized, data recorded in the i-field S13 is read out. When the data is read out from the i-field S13 and the second i-node thereof is recognized, the root directory, which is indicated by data of the starting address and the number of blocks of the data field S14, is read out from the second i-node of the i-field S13.

According to this embodiment, when the host computer 110 transmits a request for readout of the root directory, the root directory is read out from the recording medium 4 in accordance with a below-described process.

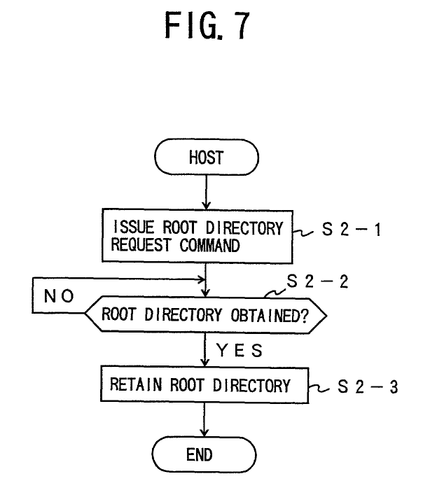

FIG. 7 is a flowchart of a process performed by the host computer of the first embodiment of the present invention.

The host computer 110 issues a command requesting the root directory to the external storage 120 via the interface unit 11 when a request for obtaining the root directory is made through an operation of an input device such as a keyboard or a mouse (step S2-1).

When the root directory request command is issued in step S2-1, the host computer 110 waits for the transmission of the root directory from the external storage 120 (step S2-2).

When obtaining the root directory from the external storage in step S2-2, the host computer 110 retains the root directory in its internal memory and displays the root directory (step S2-3).

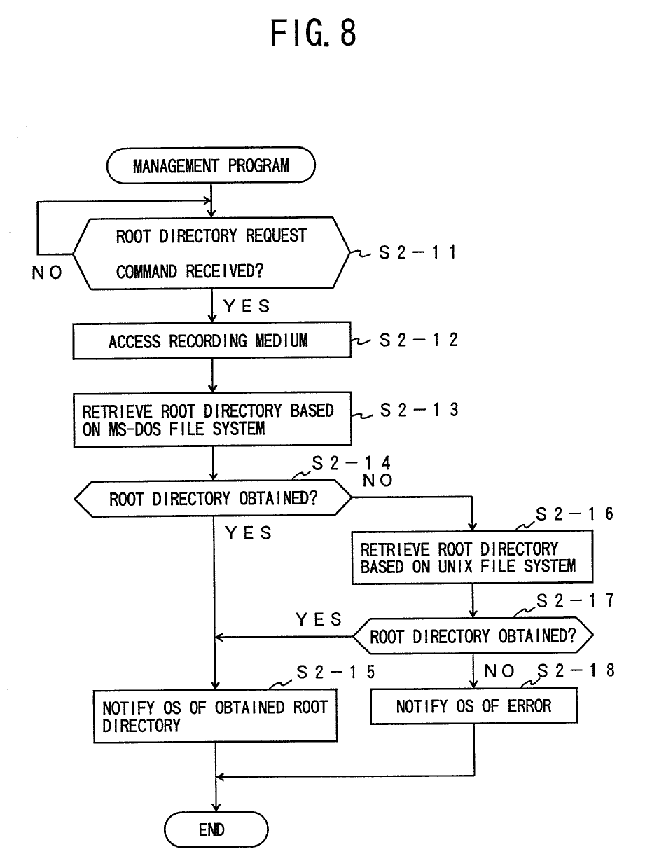

FIG. 8 is a flowchart of a process performed by the external storage of the first embodiment of the present invention.

When the external storage 120 is supplied with the request command for the root directory from the host computer 110 (step S2-11), the external storage 120 starts to access the recording medium 4 (step S2-12).

At this time, the external storage 120 retrieves the root directory by the method of retrieving the root directory from the file system of MS-DOS shown in FIG. 5 (step S2-13).

When the root directory is obtained from the recording medium 4 as a result of the retrieval in step S2-13 (step S2-14), the obtained root directory is supplied to the host computer 110 via the interface unit 21 (step S2-15).

When the root directory cannot be obtained from the recording medium 4 as a result of the access to the recording medium 4 in step S2-14, the root directory is retrieved by the method of retrieving the root directory from the file system of UNIX shown in FIG. 6 (step S2-16).

When the root directory is obtained from the recording medium 4 as a result of the retrieval in step S2-16 (step S2-17), the obtained root directory is supplied to the host computer 110 via the interface unit 21 (step S2-15).

When the root directory cannot be obtained in step S2-17, an error message is transmitted to the host computer 110 (step S2-18).

As described above, according to this embodiment, by providing the file management unit 121 with the root directory retrieval methods complying with the file systems of MS-DOS and UNIX, respectively, the root directory can be retrieved and obtained from both recording media 4 employing the file systems of MS-DOS and UNIX, respectively.

Therefore, when obtaining the root directory, the host computer 110 only needs to transmit the request command for the root directory to the external storage 120, and does not need to have a program or perform a process for retrieving the root directory. Thus, a processing load imposed on the host computer 110 can be reduced.

According to this embodiment, the error message is transmitted to the host computer 110 when the root directory cannot be obtained in either file system of MS-DOS or UNIX. However, in such a case, formatting may be automatically performed based on the file system of MS-DOS shown in FIG. 5 or the file system of UNIX shown in FIG. 6.

Further, according to this embodiment, the file management unit 121 only retrieves the root directory based on the file system of the recording medium. However, a password may be employed to authorize an access so as to maintain security.

Next, a description will be given of a second embodiment of the present invention.

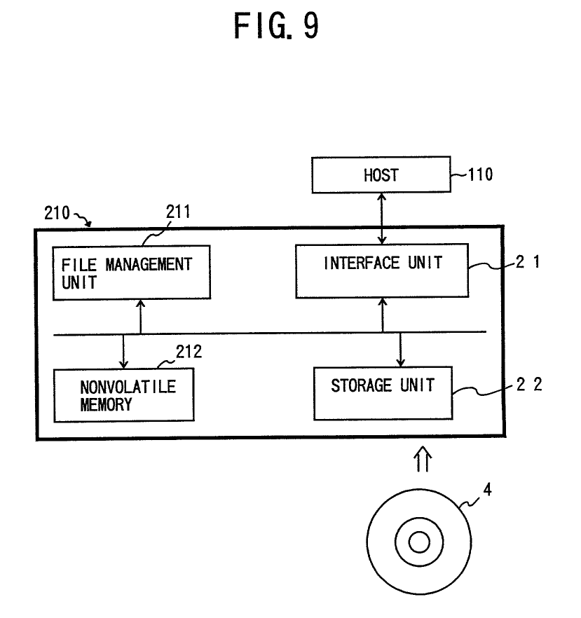

FIG. 9 is a block diagram of an external storage of the second embodiment of the present invention. In the figure, the same elements as those of FIG. 4 are referred to by the same numerals, and a description thereof will be omitted.

An external storage 210 of this embodiment includes a nonvolatile memory 212 for storing passwords in addition to the interface unit 21, the storage unit 22, and a file management unit 211. Each password is checked by the file management unit 211, and an access to the recording medium 4 is controlled based on the password.

The nonvolatile memory 212 stores the passwords.

The file management unit 211 confirms the identification of a password supplied from the host computer 110 and a password stored in the nonvolatile memory 212, and authorizes an access to the recording medium 4.

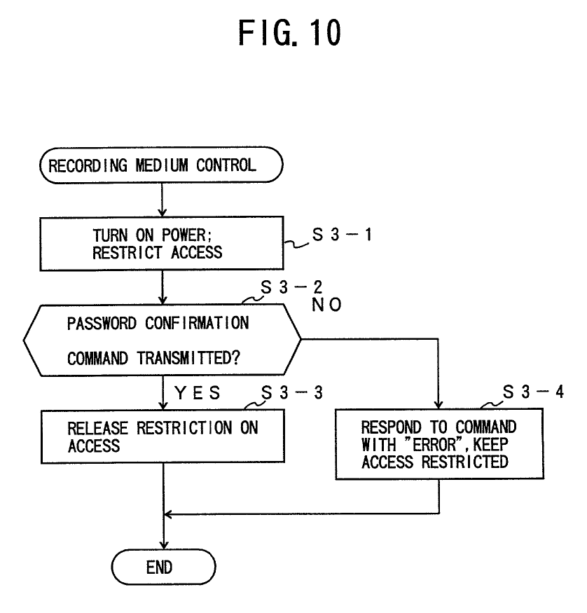

FIG. 10 is a flowchart of a process performed by the external storage of the second embodiment of the present invention.

The file management unit 211 restricts an access to the recording medium 4 from the host computer 110 when the external storage 210 is powered (step S3-1).

Next, the file management unit 211 waits for a password confirmation command from the host computer 110 with the access to the recording medium 4 from the host computer 110 being restricted in step S3-1 (step S3-2).

When, in step S3-2, the password confirmation command is supplied from the host computer 110 and a password supplied with the password confirmation command is identical to a password stored in the nonvolatile memory 212, the recording medium 4 is made accessible and the access to the recording medium 4 is allowed based on a command from the host computer 110 (step S3-3).

When, in step S3-2, a command other than the password confirmation command is supplied from the host computer 110, or the password supplied with the password confirmation command is not identical to the password stored in the nonvolatile memory 212, the access to the recording medium 4 is kept restricted (step S3-4).

According to this embodiment, the access to the recording medium 4 is authorized when the password supplied from the host computer 110 is identical to the password stored in the nonvolatile memory 212 provided in the external storage 210, thus preventing an unauthorized usage of the external storage 210 by a person who does not know the password.

Next, a description will be given of a third embodiment of an external storage according to the present invention.

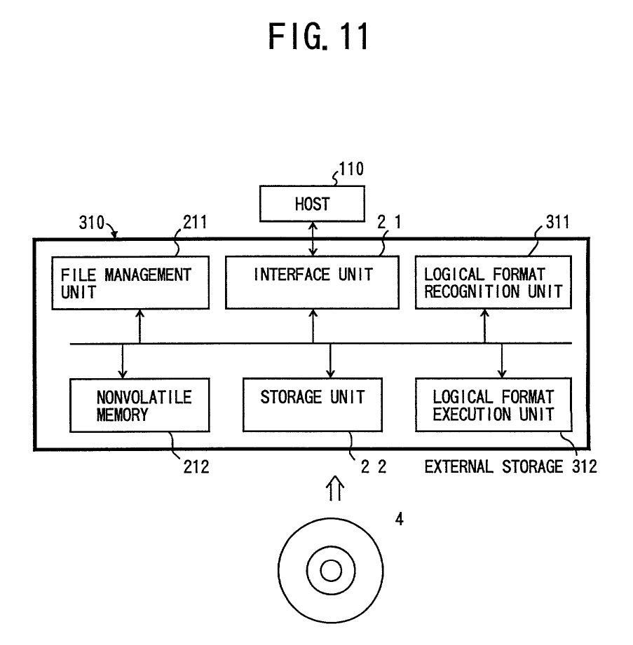

FIG. 11 is a block diagram of an external storage of the third embodiment of the present invention. In the figure, the same elements as those of FIG. 9 are referred to by the same numerals, and a description thereof will be omitted.

An external storage 310 according to this embodiment includes, in addition to the interface unit 21, the storage unit 22, the file management unit 211, and the nonvolatile memory 212, a logical format recognition unit 311 and a logical format execution unit 312 so as to format the recording medium 4.

The logical format recognition unit 311 accesses the recording medium 4 to determine whether the recording medium 4 is formatted.

When the logical format recognition unit 311 recognizes that the recording medium 4 is not formatted, the logical format execution unit 312 formats the recording medium 4.

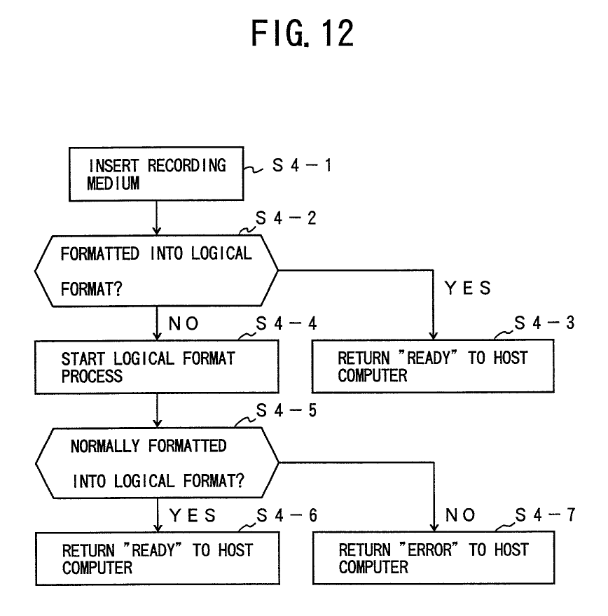

FIG. 12 is a flowchart of a process performed by the external storage of the third embodiment of the present invention.

When the recording medium 4 is inserted into the external storage 310, the logical format recognition unit recognizes the insertion of the recording medium 4 (step S4-1).

When the insertion of the recording medium 4 is recognized in step S4-1, the logical format recognition unit 311 accesses the recording medium 4 to determine whether the recording medium 4 is already formatted into a desired logical format (step S4-2). When it is determined, as a result of step S4-2, that the recording medium 4 is formatted into the desired logical format, the logical format recognition unit 311 returns a READY signal to the host computer 110 via the interface unit 21 (step S4-3).

When it is determined, as a result of step S4-2, that the recording medium 4 is not formatted into the desired logical format, the logical format recognition unit 311 activates the logical format execution unit 312. When activated by the logical format recognition unit 311, the logical format execution unit 312 controls the storage unit 22 to format the recording medium 4 into the desired logical format (step S4-4).

When the recording medium 4 is formatted into the desired logical format in step S4-4, the logical format recognition unit 311 detects a formatting state of the recording medium 4 to determine whether the formatting is performed normally (step S4-5).

When determining in step S4-5 that the recording medium 4 is formatted normally, the logical format recognition unit 311 returns the READY signal to the host computer 110 (step S4-6).

When determining in step S4-5 that the recording medium 4 is not formatted normally, the logical format recognition unit 311 returns an ERROR signal to the host computer 110 (step S4-7).

As described above, according to this embodiment, a recording medium can be automatically formatted into a desired logical format if the recording medium is not formatted into the desired logical format at the time of the insertion thereof into the external storage 310.

At this time, the host computer 110 may be designed to choose a format into which the recording medium is formatted.

In such a case, the logical format recognition unit 311 posts available logical formats to the host computer 110 and waits when it is determined in step S4-2 that the recording medium 4 is not formatted into the desired logical format. The host computer 110 displays the available logical formats posted from the logical format recognition unit 311 so that a user recognizes the available logical formats.

The user selects the desired one from the displayed available logical formats. When the user selects the desired logical format, the host computer 110 notifies the logical format recognition unit 311 of the logical format to be employed.

The logical format recognition unit 311 activates the logical format execution unit 312 so that formatting is performed employing the logical format to be employed.

Thus, formatting can be performed employing a desired format based on an instruction from a user.

Next, a description will be given of a fourth embodiment of the external storage according to the present invention. Since an external storage has the same structure as that shown in FIG. 11, a description thereof will be omitted.

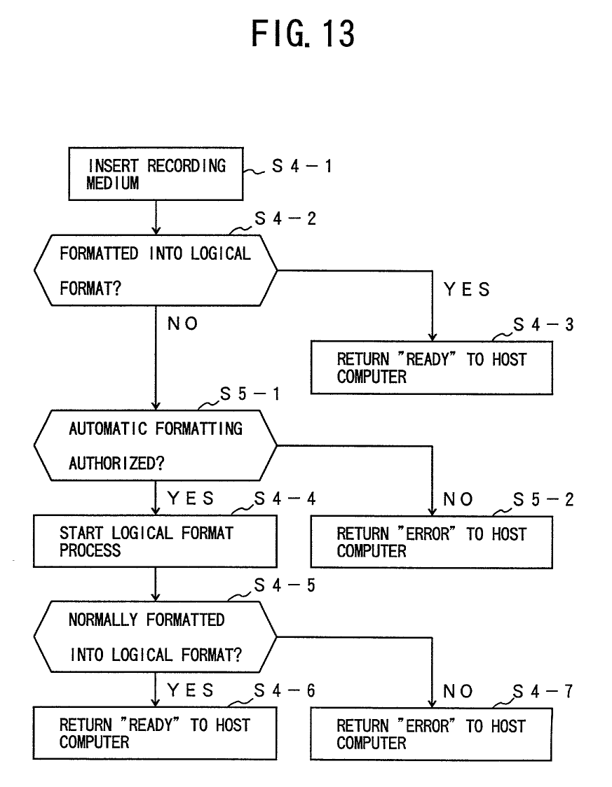

FIG. 13 is a flowchart of a process performed by the external storage of the fourth embodiment of the present invention. In the figure, the same steps as those of FIG. 12 are referred to by the same numerals, and a description thereof will be omitted.

This embodiment differs from the third embodiment in the process performed by the logical format recognition unit 311 at a time of formatting. According to this embodiment, the logical format recognition unit 311 is provided in advance with information based on which it is determined whether formatting into a desired logical format is to be performed.

The logical format recognition unit 311 controls the logical format execution unit 312 based on the provided information based on which it is determined whether formatting into a desired logical format is to be performed.

According to this embodiment, when the recording medium 4 is not formatted into the desired logical format in step S4-2, the logical format recognition unit 311 determines whether the formatting into the desired logical format is to be performed, referring to the provided information (step S5-1).

When, in step S5-1, the information which is provided in the logical format recognition unit 311 and based on which it is determined whether formatting into a desired logical format is to be performed is information authorizing the recording medium 4 to be formatted into the desired logical format, the process goes to step S4-4, in which the formatting into the desired logical format is performed. On the other hand, when, in step S5-1, the information which is provided in the logical format recognition unit 311 and based on which it is determined whether formatting into a desired logical format is to be performed is information inhibiting the recording medium 4 from being formatted into the desired logical format, “ERROR” is returned to the host computer 110 since the recording medium 4 is not to be formatted into the desired logical format (step S5-2).

Thus, according to this embodiment, since formatting into a desired format can be inhibited by a setting, the recording medium 4 is prevented from being formatted by mistake.

Next, a description will be given of a fifth embodiment of the external storage. Since an external storage has the same structure as that shown in FIG. 11, a description thereof will be omitted.

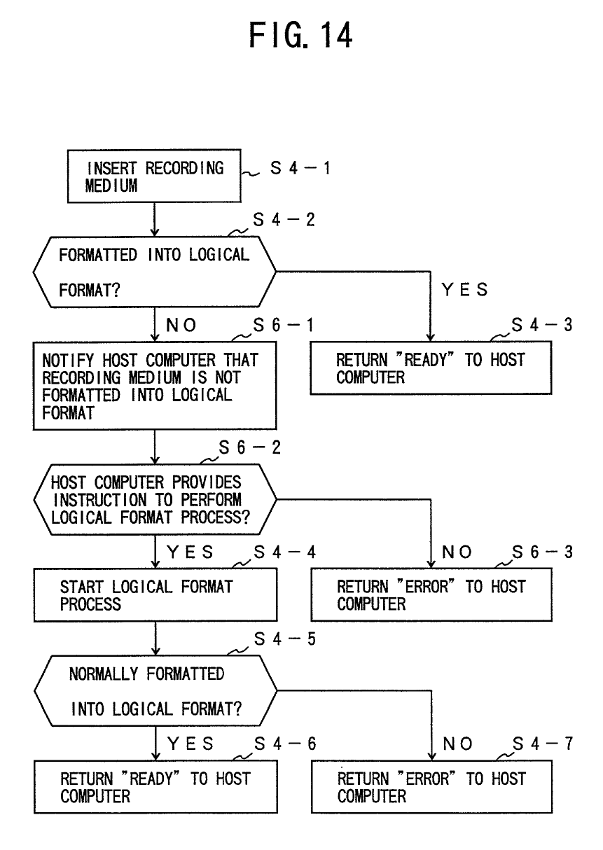

FIG. 14 is a flowchart of a process performed by the external storage of the fifth embodiment of the present invention. In the figure, the same steps as those of FIG. 12 are referred to by the same numerals, and a description thereof will be omitted.

This embodiment differs from the third and fourth embodiments in the process performed by the logical format recognition unit 311 at a time of formatting. According to this embodiment, the logical format recognition unit 311 is provided in advance with information based on which it is determined whether formatting into a desired logical format is to be performed.

Based on a command from the host computer 110, the logical format recognition unit 311 controls the logical format execution unit 312 to format the recording medium 4.

According to this embodiment, when the inserted recording medium 4 is not formatted into the desired logical format in step S4-2, the host computer 110 is notified that the inserted recording medium 4 is not formatted into the desired logical format (step S6-1).

The logical format recognition unit 311 notifies the host computer 110 that the inserted recording medium 4 is not formatted into the desired logical format, and waits for a command from the host computer 110 (step S6-2).

When a command to perform formatting is supplied from the host computer 110 in step S6-2, the process goes to step S4-4, in which the recording medium 4 is formatted into the desired logical format.

When a command not to perform formatting is supplied from the host computer 110 in step S6-2, “ERROR” is returned to the host computer 110 (step S6-3).

Thus, according to this embodiment, since formatting into a desired logical format is performed based on a command from the host computer 110, the inserted replaceable recording medium 4 is prevented from being formatted by mistake.

Next, a description will be given of a sixth embodiment of the present invention.

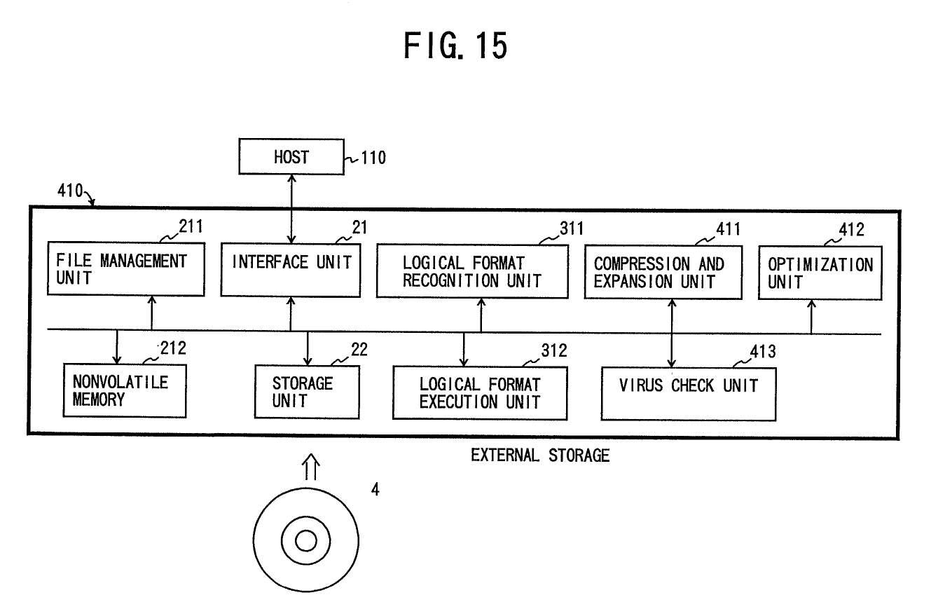

FIG. 15 is a block diagram of an external storage of the sixth embodiment of the present invention. In the figure, the same elements as those of FIG. 11 are referred to by the same numerals, and a description thereof will be omitted.

An external storage 410 of this embodiment includes a compression and expansion unit 411, an optimization unit 412, and a virus check unit 413 in addition to the interface unit 21, the storage unit 22, the nonvolatile memory 212, the file management unit 211, the logical format recognition unit 311, and the logical format execution unit 312.

The compression and expansion unit 411 compresses information to be recorded on the recording medium 4 and expands readout information.

The optimization unit 412 optimizes the arrangement of files recorded on the recording medium 4. According to the file systems of MS-DOS and UNIX, when data is recorded on the recording medium 4, the data is divided into a plurality of block addresses, but is not necessarily recorded in consecutive regions.

The optimization unit 412 performs an optimization process so as to organize the divided data into a succession. In a randomly accessible storage device such as a hard disk drive or a MO drive, when optimization is performed to read out data, the data can be read out faster, for example, by reading out a logical address block LBA1, which comes next to a logical address block LBA0, than by reading out a logical address block LBA99999, which is not next to the logical address block LBA0, after reading out the logical address block LBA0. This is because reading out the logical address block LBA1 after the logical address block LBA0 does not require a seek operation.

The virus check unit 413 performs a virus check on information to be recorded on the recording medium 4.

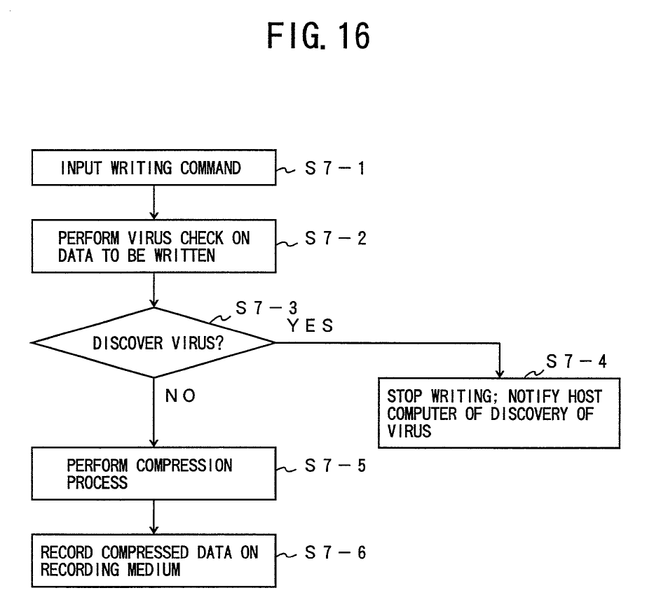

FIG. 16 is a flowchart of a process performed by the external storage of the sixth embodiment of the present invention at a time of writing information.

When a command to record information on the recording medium 4 is supplied from the host computer 110 (step S7-1), information to be recorded corresponding to the command is supplied to the virus check unit 413. The virus check unit 413 performs a virus check on the information to be recorded (step S7-2).

It is determined whether a virus is discovered as a result of the virus check performed by the virus check unit 413 (step S7-3).

When a virus is discovered in step S7-3, storing the information on the recording medium 4 is halted, and the host computer 110 is notified that the virus is discovered (step S7-4).

When no virus is discovered in step S7-3, the information to be recorded is supplied to the compression and expansion unit 411. The compression and expansion unit 411 compresses the information to be recorded (step S7-5). The information compressed in the compression and expansion unit 411 is recorded on the recording medium 4 via the storage unit 22 (step S7-6).

Next, a description will be given of the case of reading out information from the recording medium 4.

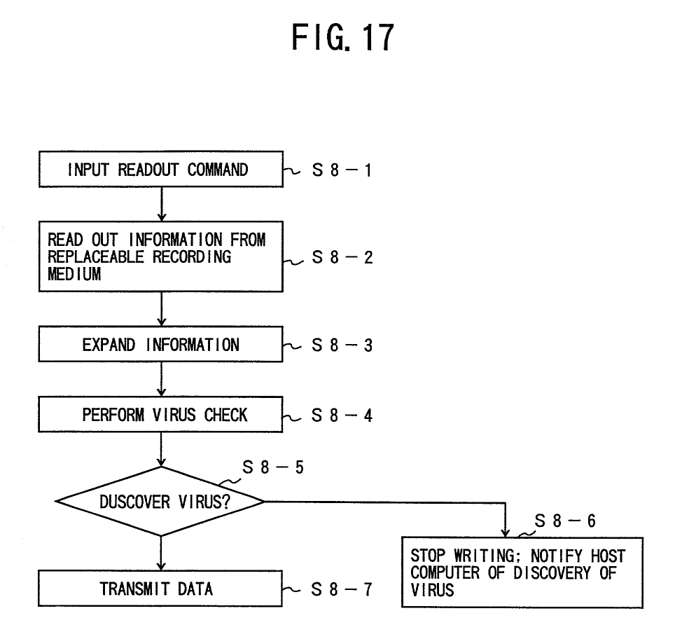

FIG. 17 is a flowchart of a process performed by the external storage of the sixth embodiment of the present invention at a time of reading out information.

When the host computer 110 supplies a command to read out information from the recording medium 4 (step S8-1), information corresponding to the command is read out from the recording medium 4 (step S8-2).

The information read out from the recording medium 4 is supplied to the compression and expansion unit 411. The compression and expansion unit 411 expands the information read out from the replaceable recording medium 4 (step S8-3).

The information expanded in the compression and expansion unit 411 is supplied to the virus check unit 413. The virus check unit 413 performs a virus check on the expanded information (step S8-4). It is determined whether a virus is discovered in the information read out from the recording medium 4 as a result of the virus check performed in step S8-4 (step S8-5).

When a virus is discovered in step S8-5, a transmission to the host computer 110 is stopped, and the host computer 110 is notified that the virus is discovered (step S8-6).

When no virus is-discovered as a result of the virus check performed by the virus check unit 413, the expanded information is transmitted to the host computer 110 (step S8-7).

Next, a description will be given of processes performed by the optimization unit 412 and the virus check unit 413.

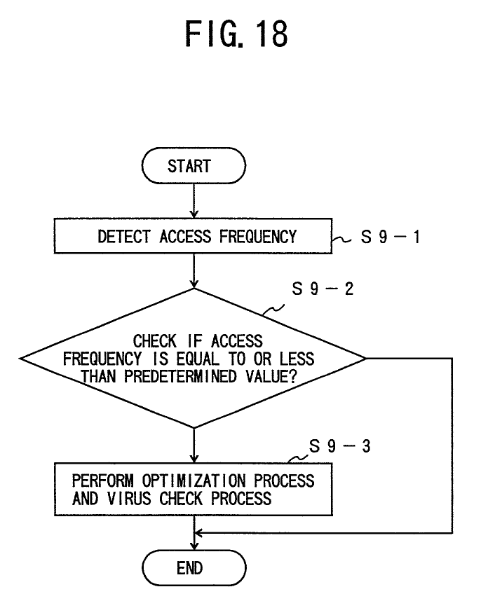

FIG. 18 is a flowchart of the processes performed by the optimization unit and the virus check unit of the sixth embodiment of the present invention.

The optimization unit 412 and the virus check unit 413 check the frequency of accesses from the host computer 110 to the recording medium 4 (step S9-1).

It is determined whether the check result of the frequency of accesses to the recording medium 4 in step S9-1 is equal to or less than a predetermined frequency (step S9-2).

When it is determined in step s9-2 that the frequency of accesses is equal to or less than the predetermined frequency, the optimization unit 412 optimizes the files of the recording medium 4 (step S9-3).

When it is determined in step S9-2 that the frequency of accesses is equal to or less than the predetermined frequency, the virus check unit 413 performs a virus check on the information of the recording medium 4 (step S9-3).

Thus, according to this embodiment, the data capacity of the replaceable recording medium 4 can be increased by compressing information to be recorded on the recording medium 4 and expanding compressed information. Since compression and expansion processes can be performed in the external storage 410, a processing load imposed on the host computer 110 is prevented from being increased.

Further, information recorded on the recording medium 4 can be organized in a succession by optimizing information to be recorded on the recording medium 4. Therefore, the recording medium 4 can be used efficiently. At this time, an optimization process can be performed in the external storage 410, thus preventing an increase in a processing load imposed on the host computer 110. Further, by performing the optimization process at a time of a low access frequency, an access process is prevented from being affected by the optimization process.

Moreover, by performing a virus check on the information to be recorded on the recording medium 4, the reliability of the information recorded on the recording medium 4 can be increased. At this time, the virus check can be performed in the external storage 410, thus preventing an increase in a processing load imposed on the host computer 110. Further, by performing the virus check at a time of a low access frequency, an access process is prevented from being affected by the virus check.

Next, a description will be given of example applications of any of the above-described first through sixth embodiments.

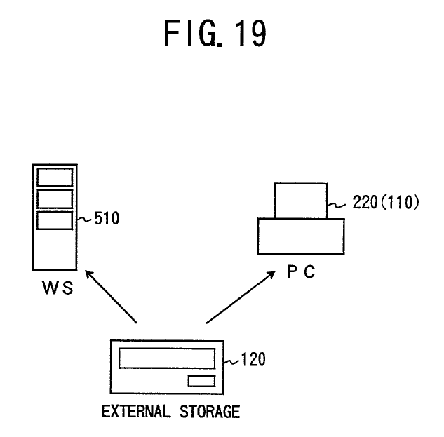

FIG. 19 is a schematic diagram of a structure of a first example application of any of the external storages of the above-described first through sixth embodiments of the present invention.

The external storage 120 can be connected to and shared by computers employing different operation systems, such as a workstation 510 and a personal computer 220, as shown in FIG. 19, by providing the file management unit 121 with a file management program for the workstation 510, and a file management program for a format of the recording medium 4 and the personal computer 220.

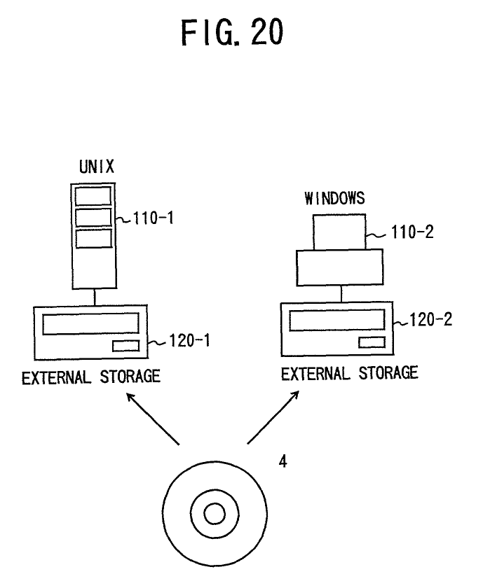

FIG. 20 is a schematic diagram of a structure of a second example application of any of the external storages of the above-described first through sixth embodiments of the present invention.

As shown in FIG. 20, the external storage 120 can be connected to either of a UNIX host computer 110-1 or a WINDOWS-type host computer 110-2, and the single recording medium 4 can be shared by the UNIX host computer 110-1 and the WINDOWS-type host computer 110-2 by providing the file management unit 121 with a file management program which manages files based on a format for UNIX and a file management program which manages files based on a format for WINDOWS.

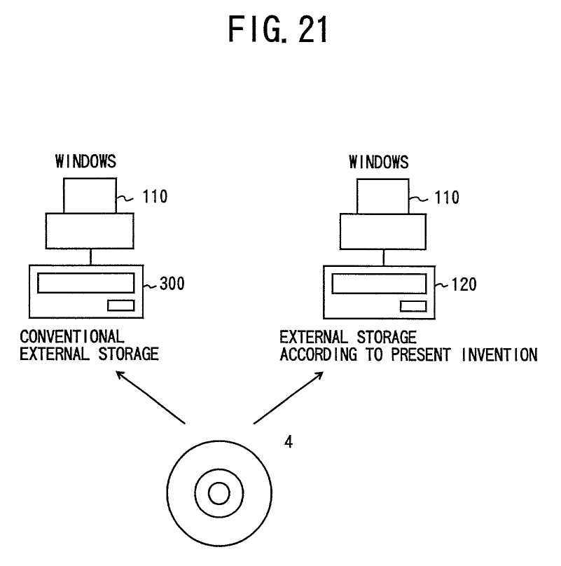

FIG. 21 is a schematic diagram of a structure of a third example application of any of the external storages of the above-described first through sixth embodiments of the present invention.

The external storage 120 of this example application has the file management unit 121 for Windows. However, even if an instruction is supplied to an external storage 300 based on the file management program of a conventional Windows system in forming the replaceable recording medium 4, the recording medium 4 can be shared by the conventional external storage 300 and the external storage 120 of the present embodiment.

Although, in these example applications, the description is given of the cases in which the file systems of UNIX and MS-DOS are employed, the present invention can be also applied to other file systems.

Thus, according to the above-described embodiments, since a host computer can automatically access a recording medium with the aid of a file management unit only by supplying a command to a storage device, the host computer does not have to execute a management program, thus reducing a processing load imposed on the host computer.

Further, by providing the file management unit included in an external storage with a formatting function of formatting a recording medium, it becomes unnecessary for the host computer to perform formatting. Therefore, since it is unnecessary to install a program for formatting a recording medium in the host computer and to execute the program therein, a processing load imposed on the host computer can be reduced.

Moreover, a recording medium can be automatically formatted by determining whether the recording medium is recorded with management information.

When it is determined that the recording medium is not recorded with the management information, a user can confirm the formatting of the recording medium, which formatting is performed by requesting the host computer to authorize the operation of the formatting function.

The operation of the formatting function can be freely set by the user.

Since the operation of the formatting function can be set from the host computer, the user can set the operation of the formatting function freely and easily.

Further, by providing the external storage with a plurality of file management programs, the files of a recording medium can be managed by a file management program which corresponds to the file management mechanism of a host computer to which the external storage is connected. Therefore, the external storage can be connected to the host computer without concern therefor.

In addition, by detecting the management information of the recording medium and selecting from the file management programs a file management program which corresponds to the detected management information, the files of the recording medium can be automatically managed by a file management program which corresponds to the file management mechanism of a host computer. Therefore, the external storage can be connected to the host computer without concern therefor.

Further, by providing the external storage with a compression and expansion unit to record compressed files on a recording medium, an increased amount of information can be recorded on the recording medium. At this time, compression and expansion processes do not have to be performed in the host computer, thus reducing a processing load imposed on the host computer.

Moreover, by providing the external storage with an optimization unit to record optimized files on a recording medium, an increased amount of information can be recorded on the recording medium. At this time, an optimization process does not have to be performed in the host computer, thus reducing a processing load imposed on the host computer.

Further, by detecting the frequency of accesses from the host computer to the recording medium and performing an optimization process at a time of a low access frequency, optimization of files can be performed automatically without hindering an access to the recording medium.

In addition, by providing the external storage with a virus check unit to perform a virus check on a file to be recorded on a recording medium, it becomes unnecessary for the host computer to perform a virus check, thus reducing a processing load imposed on the host computer. Further, a virus check can be performed even if a virus check program is not installed in the host computer.

Moreover, by performing a virus check at a time of writing files to the recording medium, the virus check can be automatically performed in the external storage.

Further, by performing a virus check at a time of recording files on the recording medium, the virus check can be automatically performed in the external storage.

Moreover, by detecting the frequency of accesses from the host computer to the recording medium and performing a virus check at a time of a low access frequency, a virus check can be automatically performed on files without hindering an access to the recording medium.

In addition, formatting into a desired format can be performed.

Furthermore, a host computer can recognize an available format and select a format.

In the above-described embodiments, the description is given of a device employing a magneto-optical recording and/or reproduction method, which device is expressed as each of the external storages 120, 210, 310, and 410. However, a recording and/or reproduction method is not limited to the magneto-optical recording and/or reproduction method, and a recording medium is not limited to a replaceable recording medium.

1. A storage device used under an environment in which the storage device is connected to and/or disconnected from each of a plurality of host computers, and recording files on a recording medium, the storage device comprising:
a file management unit which performs readout or writing management of files of the recording medium based on a command from one of the host computers.

2. The storage device as claimed in claim 1, wherein said file management unit is controlled by a plurality of file management programs corresponding to a plurality of file systems set in recording media which are usable in the storage device.

3. The storage device as claimed in claim 1, wherein said file management unit includes a formatting function of formatting the recording medium based on a predetermined file system.

4. The storage device as claimed in claim 3, wherein said file management unit detects a file system set in the recording medium, and manages a file to be recorded on the recording medium by one of file management programs corresponding to the detected file system.

5. The storage device as claimed in claim 3, wherein said formatting function includes an automatic formatting function of automatically formatting the recording medium based on the predetermined file system when the recording medium is not accessible.

6. The storage device as claimed in claim 3, wherein said formatting function requests authorization from the one of the host computers when the recording medium is formatted based on the predetermined file system.

7. The storage device as claimed in claim 5, wherein an operation of said automatic formatting function is inhabitable.

8. The storage device as claimed in claim 3, wherein said file management unit enables or disables said formatting function based on a setting by the one of the host computers.

9. The storage device as claimed in claim 1, further comprising a compression and expansion means for compressing files to be recorded on the recording medium and expanding compressed files read from the recording medium.

10. The storage device as claimed in claim 1, further comprising an optimization means for optimizing the files of the recording medium.

11. The storage device as claimed in claim 10, wherein said optimization means detects a frequency of accesses from the one of the host computers to the recording medium, and performs an optimization process when the frequency is low.

12. The storage device as claimed in claim 1, further comprising a virus check means for performing a virus check on files to be recorded on the recording medium.

13. The storage device as claimed in claim 12, wherein said virus check means performs the virus check at a time of recording a file on or reading out a file from the recording medium, or based on a frequency of accesses from the one of the host computers to the recording medium.

14. The storage device as claimed in claim 3, wherein said formatting function performs the formatting in accordance with a format corresponding to an instruction from the one of the host computers.

15. The storage device as claimed in claim 3, wherein said formatting function notifies the one of the host computers of an available format.
